(19) United States
(12) Patent Application Publication
(10) Pub. No.: US 2024/0271927 A1
(43) Pub. Date: Aug. 15, 2024

(54) PAINT THICKNESS MEASURING DEVICE AND COMPUTER-IMPLEMENTED METHOD FOR MEASURING PAINT THICKNESS

(71) Applicant: Agency for Science, Technology and Research, Singapore (SG)

(72) Inventors: Hai Sheng LEONG, Singapore (SG); Lin KE, Singapore (SG); Nan ZHANG, Singapore (SG); Qing Yang Steve WU, Singapore (SG); Sergey GORELIK, Singapore (SG); Hong LIU, Singapore (SG); Chun Yong Andrew NGO, Singapore (SG)

(21) Appl. No.: 18/693,502

(22) PCT Filed: Sep. 20, 2022
(86) PCT No.: PCT/SG2022/050670

§ 371 Date: Mar. 19, 2024

(30) Foreign Application Priority Data
Sep. 20, 2021 (SG) 10202110354W

(51) Int. Cl. G01B 11/06

(52) U.S. Cl. CPC G01B 11/0625

(57) ABSTRACT

A paint thickness measuring device and a computer-implemented method for measuring paint thickness using the same are provided. The paint thickness measuring device includes a first continuous-wave (cw) laser, a second continuous-wave laser, a photomixer, one or more computer processors, and a non-transitory computer-readable memory. The photomixer includes an optical coupler configured to mix laser lights emitted by the first and second continuous-wave lasers and generate a terahertz (THz) wave, a photomixer emitter configured to emit the terahertz wave, and a photomixer receiver configured to detect the terahertz wave reflected off a painted surface. The non-transitory computer-readable memory stores computer program instructions executable by the one or more computer processors to perform operations for paint thickness measurement. The operations include: comparing the detected terahertz wave to simulation results, identifying a minimum difference between the detected terahertz wave and the simulation results, and determining a paint thickness of the painted surface from the simulation results with the minimum difference.

### CROSS-REFERENCE TO RELATED APPLICATION

This application is a 371 National Stage of International Application No. PCT/SG2022/050670, filed on 20 Sep. 2022, which claims priority to Singapore Patent Application No. 10202110354 W, filed on 20 Sep. 2021, the content of which being hereby incorporated by reference in its entirety for all purposes.

### TECHNICAL FIELD

The present invention relates in general to paint thickness measurements and more particularly to a paint thickness measuring device and a computer-implemented method for measuring paint thickness.

### BACKGROUND

Paint serves as a protective coating for aircraft. Paint thickness is important for safety and performance of aircraft. For example, paint thickness determines the extent of damage to an aircraft when struck by lightning. Paint thickness is especially important at areas near fuel tanks as lightning could create sparks that ignite fuel.

Due to harsh weather, paint thickness of an aircraft gradually becomes thinner. Hence, aircraft are regularly repainted to ensure paint thickness is adequate.

In the aerospace industry, paint thickness measurement is an important step when repainting the fuselage of an aircraft. During a repainting process, engineers are required to measure paint thickness in order to determine how much paint is required to be put on the aircraft. Accurate measurement of the paint thickness helps ensure that the paint thickness is kept to a minimum in order to curb unnecessary payload to the aircraft, whilst ensuring that the paint thickness is not below limits set by safety regulations.

Conventionally, paint thickness measurements are performed using a tool to first bore a conical-shaped hole in the paint. Based on the angle and radius of the conical-shaped hole, the thickness of the paint is computed. Despite its simplicity, this method is destructive and has two main disadvantages. Firstly, this method risks damaging the fuselage of the aircraft if the tool drills too deeply into the paint. Secondly, this method adds additional stages to the re-painting process as after a measurement is taken, the hole has to be sealed back up with paint. Using this method, the total time required to measure the thickness of the paint at a single location including the resealing process is approximately 20 minutes. As about 500 paint thickness measurements are required for a single aircraft, this method is time-consuming and a lot of valuable time and effort is lost on sealing up the holes.

In view of the foregoing, it would be desirable to provide a non-destructive and less time-consuming paint thickness measuring device and computer-implemented method for measuring paint thickness.

### SUMMARY

Accordingly, in a first aspect, the present invention provides a paint thickness measuring device including a first continuous-wave (cw) laser, a second continuous-wave laser, a photomixer, one or more computer processors and a non-transitory computer-readable memory. The photomixer includes an optical coupler configured to mix laser lights emitted by the first and second continuous-wave lasers and generate a terahertz (THz) wave, a photomixer emitter configured to emit the terahertz wave, and a photomixer receiver configured to detect the terahertz wave reflected off a painted surface. The non-transitory computer-readable memory stores computer program instructions executable by the one or more computer processors to perform operations for paint thickness measurement. The operations include comparing the detected terahertz wave to simulation results, identifying a minimum difference between the detected terahertz wave and the simulation results, and determining a paint thickness of the painted surface from the simulation results with the minimum difference.

In a second aspect, the present invention provides a method for measuring paint thickness using the paint thickness measuring device according to the first aspect. The computer-implemented method for measuring paint thickness includes executing on one or more computer processors the steps of: comparing the detected terahertz wave to simulation results; identifying a minimum difference between the detected terahertz wave and the simulation results; and determining a paint thickness of the painted surface from the simulation results with the minimum difference.

Other aspects and advantages of the invention will become apparent from the following detailed description, taken in conjunction with the accompanying drawings, illustrating by way of example the principles of the invention.

### BRIEF DESCRIPTION OF THE DRAWINGS

Embodiments of the invention will now be described, by way of example only, with reference to the accompanying drawings, in which:

FIG. 1A is a schematic diagram illustrating a paint thickness measuring device in accordance with an embodiment of the present invention;

FIG. 1B is a graph illustrating a surface profile of a diffractive optical element (DOE) of the paint thickness measuring device of FIG. 1A;

FIG. 1C is a graph illustrating a depth profile of the DOE of the paint thickness measuring device of FIG. 1A;

FIG. 1D is a graph illustrating a cross-section of a beam at a focal spot 1 metre (m) away from the DOE of FIG. 1B;

FIG. 2 is a schematic flow diagram illustrating a computer-implemented method for measuring paint thickness using the paint thickness measuring device of FIG. 1A;

FIG. 3A is a graph illustrating a reflection spectrum detected by a photomixer receiver of the paint thickness measuring device of FIG. 1A;

FIG. 3B is a graph illustrating a comparison between the reflection spectrum of FIG. 3A and a fitted spectrum;

FIG. 3C is a graph illustrating a refractive index of a paint determined using the computer-implemented method for measuring paint thickness of FIG. 2;

FIG. 4 is a series of graphs illustrating mapping of a magnitude of a terahertz wave detected by the photomixer receiver of the paint thickness measuring device of FIG. 1A into a time-domain using a Fourier transform equation;

FIG. 5 is a series of graphs illustrating reconstruction of a detected terahertz wave with filtered magnitude and angle components from FIG. 4;

FIG. 6 is a graph illustrating a plurality of particles in a solution space for a particle swarm optimization (PSO) method;

FIG. 7 is a schematic block diagram illustrating a computer system suitable for implementing the computer-implemented method for measuring paint thickness disclosed herein;

FIG. 8A is a schematic cross-sectional diagram illustrating blue paint coated on a first composite reinforced fibre polymer (CFRP);

FIG. 8B is a graph illustrating reflected spectrums of the blue paint measured with both a conventional surface profiler and the computer-implemented method for measuring paint thickness of FIG. 2;

FIG. 9A is a schematic cross-sectional diagram illustrating blue and primer paint coated on a second CFRP; and

FIG. 9B is a graph illustrating reflected spectrums of the blue and primer paint measured with both the conventional surface profiler and the computer-implemented method for measuring paint thickness of FIG. 2.

### DETAILED DESCRIPTION

The detailed description set forth below in connection with the appended drawings is intended as a description of presently preferred embodiments of the invention, and is not intended to represent the only forms in which the present invention may be practiced. It is to be understood that the same or equivalent functions may be accomplished by different embodiments that are intended to be encompassed within the scope of the invention.

The term “about” as used herein refers to both numbers in a range of numerals and is also used to indicate that a value includes the standard deviation of error for the device or method being employed to determine the value. The term “about” as used herein can allow for a degree of variability in a value or range, for example, within 10%, within 5%, or within 1% of a stated value or of a stated limit of a range.

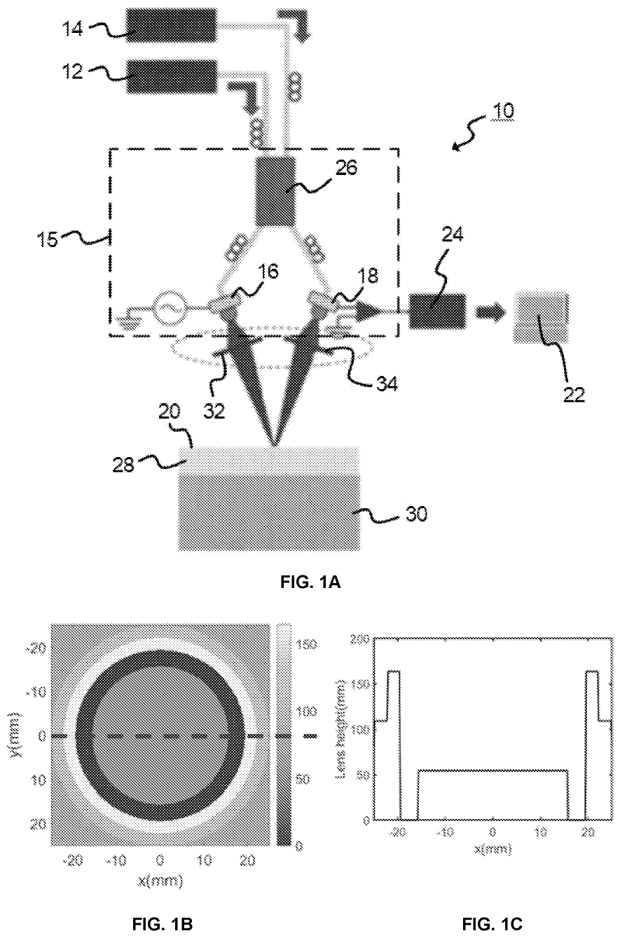

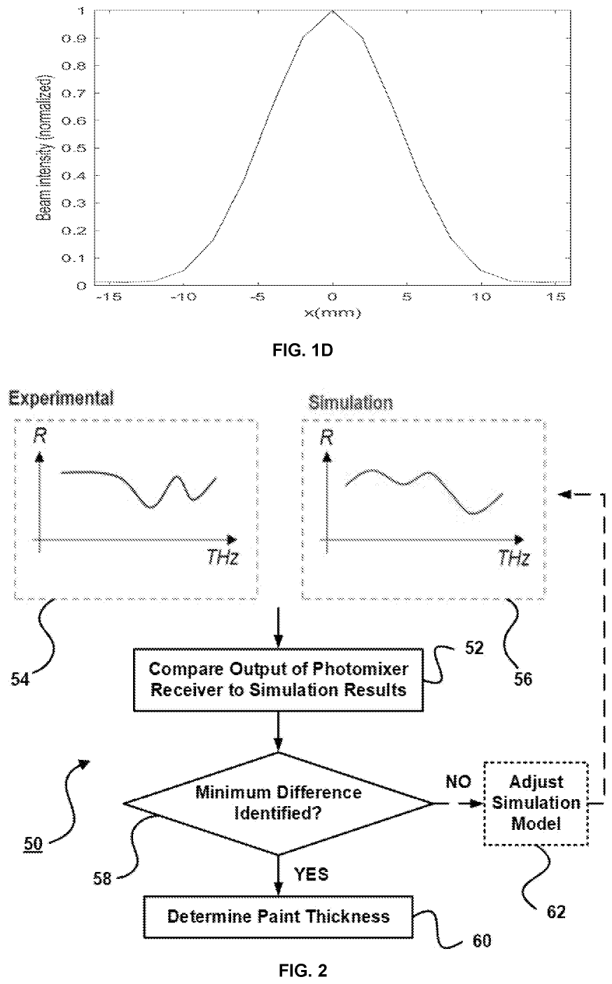

Referring now to FIG. 1A, a paint thickness measuring device 10 is shown. The mechanical structure and control systems employed by the paint thickness measuring device 10 are shown in FIG. 1A.

The paint thickness measuring device 10 includes a first continuous-wave (cw) laser 12, a second continuous-wave laser 14, a photomixer 15, one or more computer processors 22 and a non-transitory computer-readable memory 24. The photomixer 15 includes an optical coupler 26 configured to mix laser lights emitted by the first and second continuous-wave lasers 12 and 14 and generate a terahertz (THz) wave, a photomixer emitter 16 configured to emit the terahertz wave, and a photomixer receiver 18 configured to detect the terahertz wave reflected off a painted surface 20. The non-transitory computer-readable memory 24 stores computer program instructions executable by the one or more computer processors 22 to perform operations for paint thickness measurement. The operations include comparing the detected terahertz wave to simulation results, identifying a minimum difference between the detected terahertz wave and the simulation results, and determining a paint thickness of the painted surface 20 from the simulation results with the minimum difference.

The first and second continuous-wave lasers 12 and 14 are used to generate THz waves and may each be a Distributed Feedback (DFB) laser. The DFB lasers 12 and 14 may be tunable and may come in a butterfly package form with a footprint of approximately 3 millimetres (mm). Probe wavelength may be between about 249 microns (μm) and about 2 mm, corresponding to a frequency range of between about 0.15 terahertz (THz) and about 1.2 THz.

Output from the two (2) tunable DFB lasers 12 and 14 is mixed at the photomixer 15 to create a beat frequency in a terahertz (THz) range. Two (2) continuous wave lasers with identical polarisations are sent into the photomixer 15 in which the lasers with frequency ω₁ and ω₂ are spatially overlapped to generate a terahertz beat note. Advantageously, terahertz (THz) frequencies in a range of between about 0.1 THz and about 10 THz are transparent in non-conductive materials such as paint and polymer composites and are thus able to provide a non-destructive and non-contact approach to measuring paint thickness. The photomixer 15 may include an ultra-fast photoconductive semiconductor material such as, for example, low temperature gallium arsenide (GaAs) with a patterned metalized layer which is used to form an electrode array and a radiating antenna. The co-linear lasers 12 and 14 are used to illuminate the ultra-fast semiconductor material. Photonic absorption and short-charge carrier lifetime results in modulation of the conductivity at a desired terahertz frequency ω_{THz}=ω₁−ω₂. An applied electric field allows the conductivity variation to be converted into a current which is radiated by a pair of antennas (the photomixer emitter 16 and the photomixer receiver or detector 18). Photocurrent generated by the ultra-fast photoconductive semiconductor material oscillates at the beat frequency and is then converted to THz waves via the antenna surrounding the photomixer.

The optical coupler 26 couples outputs of the first and second continuous-wave lasers 12 and 14 and sends a mixed output into both the photomixer emitter 16 and the photomixer receiver 18. The optical coupler 26 may be an optical fibre coupler.

The photomixer receiver 18 is used for detecting the THz radiation and may include a tunable heterodyne mixer with an internal local oscillator. Accordingly, detection of the THz waves may be performed via an optical heterodyne method where the incoming THz waves are mixed with the local oscillator. From the mix, a signal that carries the information may be isolated.

Surface type of the painted surface 20 may vary from homogeneous (smooth surfaces) to inhomogeneous (carbon fibre reinforced polymer). The painted surface 20 may be of either a single layer or multiple layers (up to four (4) layers) of paint 28 applied on a substrate 30. In a multiple paint layer embodiment, each layer of paint 28 may be within a range of less than about 100 microns (μm) down to 40 μm. The substrate 30 may be a homogeneous substrate (e.g., silicon), an inhomogeneous substrate (e.g. carbon fibre reinforced polymer), an anisotropic substrate or an isotropic substrate.

The paint thickness measuring device 10 provides a continuous-wave terahertz (cw-THz) system that consists primarily of two (2) Distributed Feedback (DFB) lasers 12 and 14 and two (2) THz photomixers 16 and 18 interlocked in a heterodyne detection scheme, the continuous-wave terahertz (cw-THz) system being used to generate and detect terahertz (THz) waves.

To allow for long-range probing, the paint thickness measuring device 10 may include a first Fresnel lens 32 configured to focus the emitted terahertz wave from the photomixer emitter 16 and a second Fresnel lens 34 configured to refocus the terahertz wave reflected off the painted surface 20, each of the first and second Fresnel lenses 32 and 34 having a diffractive optical element (DOE). The first Fresnel lens 32 is provided at the photomixer emitter 16 to reduce losses from the photomixer emitter 16 to far-field, enabling an output beam to probe the paint 28 at further distances. With better coupling to the photomixer emitter 16, wide band with strong focusing in THz long range may be achieved. Further advantageously, as terahertz (THz) waves have long wavelengths, the second Fresnel lens 34 provided at the photomixer receiver 18 helps mitigate scattering of a signal when reflected off the painted surface 20 and thereby improves signal collection at the photomixer receiver 18. Through provision of the first and second Fresnel lenses 32 and 34, terahertz (THz) waves from the paint thickness measuring device 10 benefit from having sufficient energy to reach far-field distances and collection of the scattered signal from the painted surface 20 is enhanced. Advantageously, this allows the paint thickness measuring device 10 to be fitted on unmanned aerial vehicles such as, for example, drones to probe paint surfaces from a safe distance with sufficient room to manoeuvre while probing the paint.

Design of the first and second Fresnel lenses 32 and 34 may be based on specific divergence angles of an individual THz emitter. Ring belt teeth of the first and second Fresnel lenses 32 and 34 and ring height of the first and second Fresnel lenses 32 and 34 may be simulated and obtained through iterative relationship simulation with the divergence angle of the photomixer emitter 16. Each of the first and second Fresnel lenses 32 and 34 may have a diameter of about 100 mm and a height of about 164 μm. THz emitted power density and focal plane position of the flat lens after the emitter may also be simulated. In this way, loss between the THz emitter 16 and the first Fresnel lens 32 may be reduced to a minimum and the focused beam may achieve increased intensity and penetration, thus higher resolution in a long distance far field. In one or more embodiments, the first and second Fresnel lenses 32 and 34 may be specifically designed to cater to input and output beam parameters of the photomixer 15 and focus the THz beam at a distance of 1 m. Surface profiles of the first and second Fresnel lenses 32 and 34 may be optimized for collection of THz radiation to and from the emitter 16 and the object 28 at the receiver side according to the reflection geometry of the reflected THz beam from the paint surface (simulated). A wide range of different angles of reflection due to strong scattering of the THz beam may be considered in the surface profile optimization at the receiver side. Collection of stable and stronger signals ensures sensitive detection and vibration resistance detection. The first and second Fresnel lenses 32 and 34 may be made of silicone or high resistivity silicon as it is transparent in the THz region (0.1 THz to 2.5 THz).

To allow the paint thickness measuring device 10 to probe paint surfaces from a distance, the Fresnel lenses may be designed to focus the THz beam at the distance of, for example, about 1 metre (m). Accordingly, each of the first and second Fresnel lenses may have a focal length of between about 10 centimetres (cm) and about 100 cm, preferably about 1 m. Such long-range Fresnel lenses allow the paint thickness measuring device 10 to probe surfaces at a distance of 1 m.

Each of the first and second Fresnel lenses 32 and 34 may have a refractive index of about 3.44.

A centre frequency of the Fresnel lenses may be at 0.75 THz with a wide range of 0.5 THz to 1.5 THz.

The Fresnel lenses 32 and 34 may be a flat lens in the terahertz (THz) range.

Advantageously, by using the flat lenses, the paint thickness measuring device 10 is light-weight, robust, compact, low cost and easy to integrate.

Referring now to FIGS. 1B and 1C, the DOE may have a diameter of about 50 mm and a groove height of about 83 μm.

Referring now to FIG. 1D, a cross-section of a beam at a focal spot, 1 metre (m) away from the Fresnel lens is shown. As can be seen from FIG. 1D, a spot-size of the beam at the focal spot is 12 millimetres (mm) and the full-width-half-maximum (FWHM) of the beam is 12 mm.

Referring again to FIG. 1A, lock-in detection electronics 24 may also be provided. The lock-in detection electronics 24 may include a type of amplifier that is configured to extract a signal with a known carrier wave from an extremely noisy environment, in particular, extracting signals in a defined frequency band around a reference frequency, efficiently rejecting all other frequency components.

Advantageously, components of the paint thickness measuring device 10 may be fitted in a shoebox, making the paint thickness measuring device 10 compact.

The operations for paint thickness measurement performed when the computer program instructions stored in the non-transitory computer-readable memory 24 are executed by the one or more computer processors 22 will now be described below with reference to FIG. 2.

Referring now to FIG. 2, a computer-implemented method 50 for measuring paint thickness using the paint thickness measuring device 10 of FIG. 1 is shown. The method 50 for measuring paint thickness may be executed on the one or more processors 22.

The paint thickness measurement method 50 begins at step 52 by comparing the detected terahertz wave 54 to simulation results 56.

At step 58, a minimum difference between the detected terahertz wave 54 and the simulation results 56 is identified. This may be by using a calibration table or a numerical regression technique known as inverse modelling.

At step 60, a paint thickness of the painted surface 20 is determined from the simulation results 56 with the minimum difference.

In an embodiment where the thickness of paint or a film is determined from a calibration table, the simulation results may be stored in the calibration table and the minimum difference or error may be identified by comparing the detected terahertz wave to the simulation results stored in the calibration table.

In an embodiment where the thickness and/or refractive index of paint or a film is determined from the numerical regression technique, the paint thickness measurement method 50 may include a step 62 of adjusting material parameters and a simulated paint thickness of a simulation model to minimise a difference between the detected terahertz wave 54 and the simulation model 56. Material parameters such as, for example, Ep (Permittivity), Delta (conductivity), Tau (relaxation time (s)), Alpha (dimensionless parameter that accounts for imperfection), Sigma (shape parameter), Tau (drude) (relaxation time for Drude model), etc. and thickness of the coating may be adjusted by setting a small range for each of the parameters. The algorithm automatically searches for the best fit and finalizes the parameters.

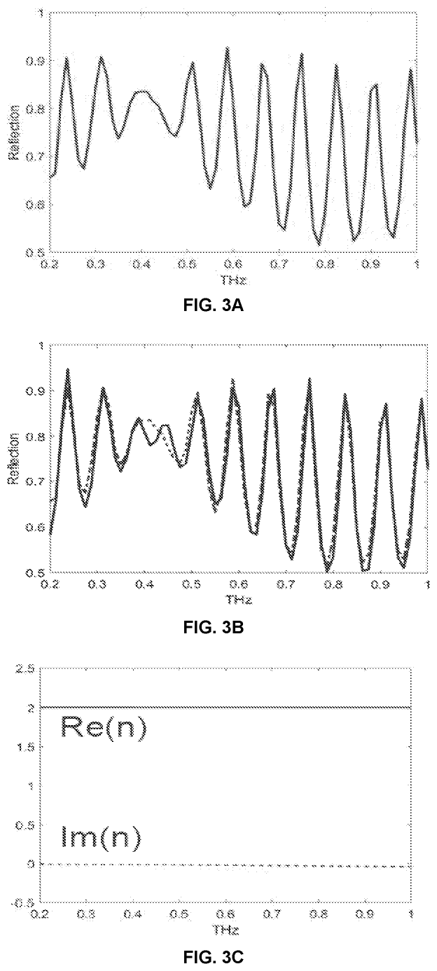

Referring now to FIGS. 3A through 3C, an example of the paint thickness measurement method 50 utilizing an optimization procedure known as inverse modelling will now be described. This paint thickness measurement algorithm compares the values received from the THz photomixer receiver 18 shown in FIG. 3A to a simulation model. A set of parameters of the simulation model including paint thickness is then adjusted to minimize a difference between the detected terahertz wave and the simulation model. A particle swarm optimization (PSO) method may be used to minimise the difference between the detected terahertz wave and the simulation model. PSO is a stochastic optimization technique based on the movement and intelligence of swarms. It uses a number of particles that constitute a swarm moving around in a search space, looking for the best solution. Once the error is minimised as shown in FIG. 3B, the paint thicknesses from this set of optimal parameters are concluded as the actual thickness of the paint layers as shown in exemplary Table 1 below.

TABLE 1
Topcoat Paint Thickness

| Actual | Fit |
|---|---|
| 91 μm | 89 μm |

A refractive index of the paint may similarly be determined as shown in FIG. 3C.

The difference between the detected terahertz wave 54 and the simulation model may be represented by an error function defined by a cross-correlation of the detected terahertz wave 54 and the simulation model as defined by Equations (1) and (2):

$${r}_{i n} ★ {r}_{trial} ( τ ) = {\int }_{- ∞}^{∞} {r}_{i n} ( f ) {r}_{trial}^{*} ( f + τ ) df \qquad ( 1 )$$

$$F \{ {r}_{i n} ★ {r}_{trial} ( τ ) \} = {R}_{i n} ( t ) * {R}_{trial} ( t ) \qquad ( 2 )$$

where τᵢₙ represents the detected terahertz wave, rₜᵣᵢₐₗ represents a simulated wave, t represents a dummy variable for integration, f represents frequency, Rᵢₙ represents a Fourier transform pair of rᵢₙ, Rₜᵣᵢₐₗ represents Fourier transform pair of rₜᵣᵢₐₗ, t represents a time delay, and Equation (2) is a Fourier transform of Equation (1).

In the inverse modelling procedure, the error or objective function defines the error between the detected terahertz wave and the simulation model. When well defined, the objective function greatly improves accuracy and precision of the optimization protocol. The error function defined in Equation (1) is a cross-correlation of the experimental result and the simulation model. The objective function in the numerical regression technique defines the cross-correlation between experimental and simulated spectrums and accurately matches the profile of the simulated spectrum to the experimental spectrum.

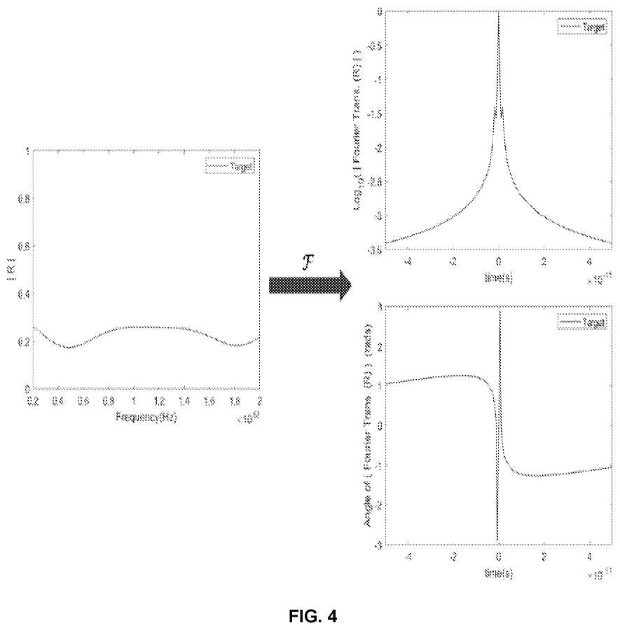

Referring now to FIG. 4, the step 58 of identifying the minimum difference between the detected terahertz wave 54 and the simulation results 56 in the paint thickness measurement method 50 may include mapping a magnitude of the detected terahertz wave into a time-domain using Equation (2) to obtain a magnitude component and an angle component as shown. More particularly, the “experimental input” is the magnitude of the wave reflected by the paint 28, scanned as a function of THz frequency. The magnitude of the reflected wave, |Rᵢₙₚᵤₜ|, is mapped into the time-domain using the Fourier Transform. The Fourier transform of |Rᵢₙₚᵤₜ| is defined by Equation (5):

$$F \{ \vert {r}_{input} ( f ) \vert \} = {\int }_{- ∞}^{∞} \vert {r}_{input} ( f ) \vert {e}^{- i 2 π tf} df \qquad ( 5 )$$

The constituents of the Fourier Transform are described by the magnitude (top) and the angle (bottom).

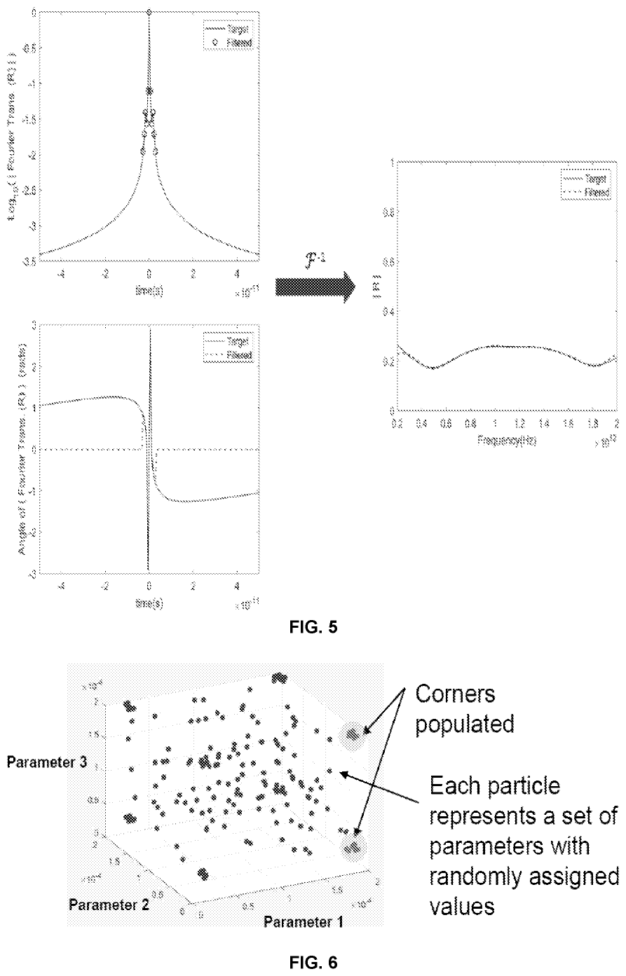

Referring now to FIG. 5, the step 58 of identifying the minimum difference between the detected terahertz wave 54 and the simulation results 56 in the paint thickness measurement method 50 may further include performing a filtering operation to remove the magnitude and angle components in the time-domain that are orders of magnitude lower than the magnitude and angle components at t=0. At t=0, which is the centre-point of the Fourier transform curve, there will be a lot of noisy data of several orders of magnitude lower. The paint thickness measurement method 50 removes components in the time-domain that are orders of magnitude lower than the component at t=0 as these components are not significant and do not contribute to the subsequent reconstruction of the reflectance curve in the frequency-domain. The noise is automatically removed when FFT process is performed with different types of filters. Advantageously, this helps to prevent inaccurate results due to these non-essential components.

The step 58 of identifying the minimum difference between the detected terahertz wave 54 and the simulation results 56 in the paint thickness measurement method 50 may further include reconstructing the detected terahertz wave with the filtered magnitude and angle components. As can be seen from FIG. 5, reconstruction of the reflectance spectrum with the filtered components shows that the profile is maintained.

The step 58 of identifying the minimum difference between the detected terahertz wave 54 and the simulation results 56 in the paint thickness measurement method 50 may further include computing cross-correlational errors between the input function and the trial function using Equations (3) and (4):

$${Error}_{magn} = \vert {\int }_{- t}^{t} ( \frac{\vert {R}_{i n} ( t ) \vert \vert {R}_{trial} ( t ) \vert - {\vert {R}_{i n} ( t ) \vert}^{2}}{{\vert {R}_{i n} ( t ) \vert}^{2}} - 1 ) dt \vert \qquad ( 3 )$$

$${Error}_{phase} = \vert {\int }_{- t}^{t} ( {φ}_{trial} ( t ) - {φ}_{i n} ( t ) ) dt \vert \qquad ( 4 )$$

where Error_{magn} represents a magnitude of a cross-correlational error function, Errorₚₕₐₛₑ represents a phase of cross-correlational error function, φₜᵣᵢₐₗ represents a phase of Rₜᵣᵢₐₗ, and φᵢₙ represents a phase of Rᵢₙ. The next step in the paint thickness measurement method 50 is to compute the cross-correlation errors between the input and the trial functions. The error may be divided into two segments: magnitude and phase. When the error achieves a minimum point, the solution is found.

A transfer-matrix method may be used in optics to analyze propagation of electromagnetic through a stratified medium and may be used for multilayer coatings reflection peaks analysis. The transfer-matrix method is based on the fact that according to Maxwell's equations, there are simple continuity conditions for electric field across boundaries from one medium to the next.

Referring now to FIG. 6, a particle initiation step in the particle swarm optimization (PSO) method may be modified to include populating corners of a solution space with a plurality of particles to increase chances of finding a solution near parameter limits. During “particle initiation” stage of the PSO method, a set of particles are randomly and uniformly distributed within a solution space as shown in FIG. 6, each particle representing a set of parameters with randomly assigned values and a potential match to the detected terahertz wave. As the optimization process progresses, these particles slowly converge to a point in the solution space. However, if an actual solution is near the parameter limits, the search algorithm may miss the actual solution and the particles may converge to a false solution. To rectify this, particles may be populated very close to the corners of the limits of the solution space in addition to uniform random distribution of the particles within the solution space during the “particle initiation” stage as shown, for example, in FIG. 6. The corners of the solution space are populated to increase the chances of finding a true solution that is close to the limits of the solution space. Advantageously, by populating the corners of the solution space with a plurality of particles, chances of the search algorithm finding solutions that are near the limits are increased and algorithm processing time is considerably reduced.

Referring again to FIG. 1A, the paint thickness measuring device 10 uses the described tailor-made algorithms to determine thicknesses several orders smaller than incident wavelength, allowing the continuous-wave terahertz (cw-THz) system 10 to measure paint thickness less than 100 μm. The algorithm employs the inverse modelling method which compares the experimental data with a simulation model. An optimization algorithm is then used to adjust a set of parameters in the simulation model until results from the simulation matches the experiments.

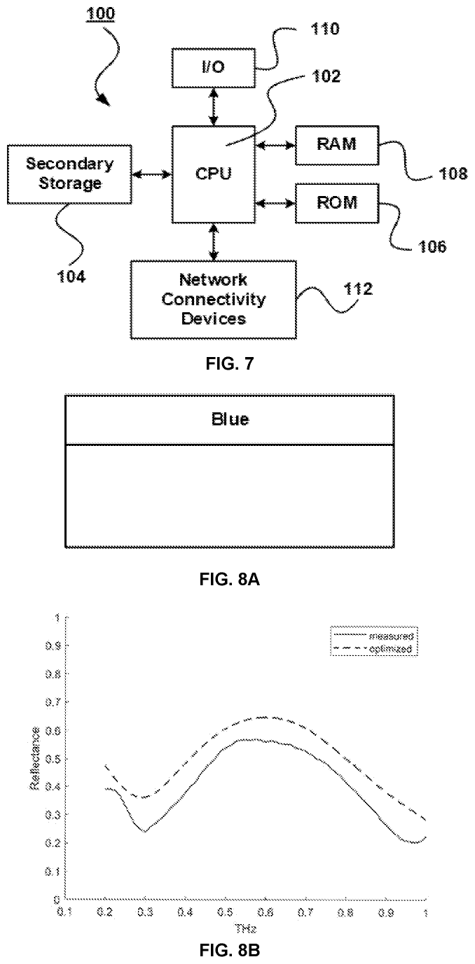

Referring now to FIG. 7, a computer system 100 suitable for implementing the paint thickness measurement method 50 of FIG. 2 is shown. The computer system 100 includes a processor 102 (which may be referred to as a central processor unit or CPU) that is in communication with memory devices including secondary storage 104, read only memory (ROM) 106, random access memory (RAM) 108, input/output (I/O) devices 110, and network connectivity devices 112. The processor 102 may be implemented as one or more CPU chips.

It is understood that by programming and/or loading executable instructions onto the computer system 100, at least one of the CPU 102, the RAM 108, and the ROM 106 are changed, transforming the computer system 100 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 100 is turned on or booted, the CPU 102 may execute a computer program or application. For example, the CPU 102 may execute software or firmware stored in the ROM 106 or stored in the RAM 108. In some cases, on boot and/or when the application is initiated, the CPU 102 may copy the application or portions of the application from the secondary storage 104 to the RAM 108 or to memory space within the CPU 102 itself, and the CPU 102 may then execute instructions that the application is comprised of. In some cases, the CPU 102 may copy the application or portions of the application from memory accessed via the network connectivity devices 112 or via the I/O devices 110 to the RAM 108 or to memory space within the CPU 102, and the CPU 102 may then execute instructions that the application is comprised of. During execution, an application may load instructions into the CPU 102, for example load some of the instructions of the application into a cache of the CPU 102. In some contexts, an application that is executed may be said to configure the CPU 102 to do something, for example, to configure the CPU 102 to perform the function or functions promoted by the subject application. When the CPU 102 is configured in this way by the application, the CPU 102 becomes a specific purpose computer or a specific purpose machine.

The secondary storage 104 is typically comprised of one or more disk drives or tape drives and is used for non-volatile storage of data and as an over-flow data storage device if RAM 108 is not large enough to hold all working data. Secondary storage 104 may be used to store programs which are loaded into RAM 108 when such programs are selected for execution. The ROM 106 is used to store instructions and perhaps data which are read during program execution. ROM 106 is a non-volatile memory device which typically has a small memory capacity relative to the larger memory capacity of secondary storage 104. The RAM 108 is used to store volatile data and perhaps to store instructions. Access to both ROM 106 and RAM 108 is typically faster than to secondary storage 104. The secondary storage 104, the RAM 108, and/or the ROM 106 may be referred to in some contexts as computer readable storage media and/or non-transitory computer readable media.

I/O devices 110 may include cameras, printers, video monitors, liquid crystal displays (LCDs), plasma displays, touch screen displays, keyboards, keypads, switches, dials, mice, track balls, voice recognizers, card readers, paper tape readers, or other well-known input devices. The network connectivity devices 112 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 112 may enable the processor 102 to communicate with the Internet or one or more intranets. With such a network connection, it is contemplated that the processor 102 might receive information from the network, or might output information to the network in the course of performing the above-described method steps. Such information, which is often represented as a sequence of instructions to be executed using processor 102, may be received from and outputted to the network, for example, in the form of a computer data signal embodied in a carrier wave. Such information, which may include data or instructions to be executed using processor 102 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 102 executes instructions, codes, computer programs, scripts which it accesses from hard disk, floppy disk, optical disk (these various disk-based systems may all be considered secondary storage 104), flash drive, ROM 106, RAM 108, or the network connectivity devices 112. While only one processor 102 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 104, for example, hard drives, floppy disks, optical disks, and/or other device, the ROM 106, and/or the RAM 108 may be referred to in some contexts as non-transitory instructions and/or non-transitory information.

In an embodiment, the computer system 100 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 100 to provide the functionality of a number of servers that is not directly bound to the number of computers in the computer system 100. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 100, at least portions of the contents of the computer program product to the secondary storage 104, to the ROM 106, to the RAM 108, and/or to other non-volatile memory and volatile memory of the computer system 100. The processor 102 may process the executable instructions and/or data structures in part by directly accessing the computer program product, for example by reading from a CD-ROM disk inserted into a disk drive peripheral of the computer system 100. Alternatively, the processor 102 may process the executable instructions and/or data structures by remotely accessing the computer program product, for example by downloading the executable instructions and/or data structures from a remote server through the network connectivity devices 112. The computer program product may comprise instructions that promote the loading and/or copying of data, data structures, files, and/or executable instructions to the secondary storage 104, to the ROM 106, to the RAM 108, and/or to other non-volatile memory and volatile memory of the computer system 100.

In some contexts, the secondary storage 104, the ROM 106, and the RAM 108 may be referred to as a non-transitory computer readable medium or a computer readable storage media. A dynamic RAM embodiment of the RAM 108, likewise, may be referred to as a non-transitory computer readable medium in that while the dynamic RAM receives electrical power and is operated in accordance with its design, for example during a period of time during which the computer system 100 is turned on and operational, the dynamic RAM stores information that is written to it. Similarly, the processor 102 may comprise an internal RAM, an internal ROM, a cache memory, and/or other internal non-transitory storage blocks, sections, or components that may be referred to in some contexts as non-transitory computer readable media or computer readable storage media.

### Experimental Results

Referring now to FIGS. 8A and 8B, the total thickness of a blue paint coated on a composite reinforced fibre polymer (CFRP) as shown in FIG. 8A was measured with a conventional surface profiler and using the paint thickness measurement method 50 described above. To apply the paint thickness measurement method 50, the reflected spectrum of the blue paint was first obtained and then fitted into the paint thickness measurement algorithm 50. The total thickness of the blue paint was then measured using the surface profiler and compared to the results obtained from the paint thickness measurement method 50. Table 2 below shows the total thickness of the blue paint measured with the surface profiler and the thickness determined from the paint thickness measurement method 50.

TABLE 2

| | Measured with | Thickness determined from Paint |
|---|---|---|
| Paint | Surface Profiler | Thickness Measurement Method |
| Total Thickness | 55 μm | 52 μm |

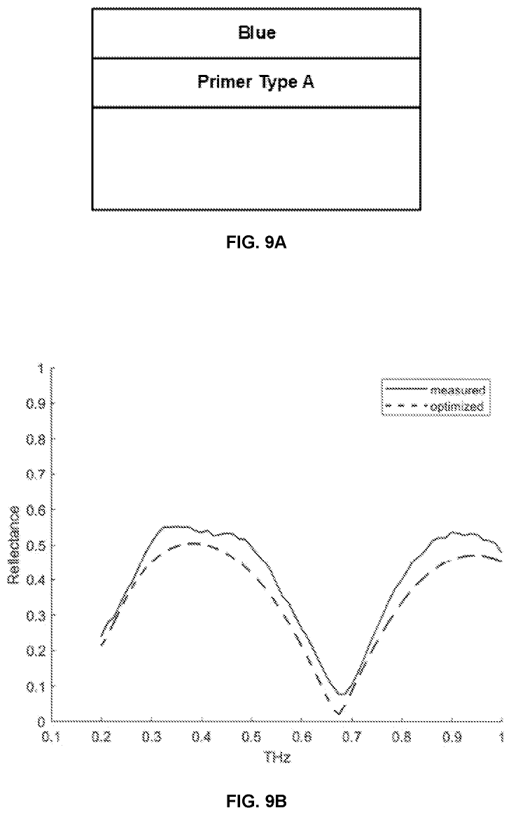

Referring now to FIGS. 9A and 9B, the total thickness of a blue and primer paint coated on a composite reinforced fibre polymer (CFRP) as shown in FIG. 9A was also measured with a conventional surface profiler and using the paint thickness measurement method 50 described above. Table 3 below shows the total thickness of the blue and primer measured with the surface profiler and the thickness determined from the paint thickness measurement method 50.

TABLE 3

| | Measured with | Thickness determined from Paint |
|---|---|---|
| Paint | Surface Profiler | Thickness Measurement Method |
| Total Thickness | 152 μm | 131 μm |

Table 4 below shows a comparison between the thickness measured with a conventional surface profiler and the thickness obtained from the paint thickness measurement method 50.

TABLE 4

| | | Thickness | | |
|---|---|---|---|---|
| | | determined | | |
| | Measured | from Paint | | |
| | with | Thickness | | |
| Paint | Surface | Measurement | Measurement | |
| Construct | Profiler | Method | Error | |
| Blue and primer | 152 μm | 131 μm | −21 | μm |
| coat on CFRP | (total) | (total) | | |
| Blue and primer | 115 μm | 104 μm | −11 | μm |
| coat on CFRP | (total) | (total) | | |
| Blue and primer | 145 μm | 133 μm | −11 | μm |
| coat on CFRP | (total) | (total) | | |
| Blue coat on CFRP | 55 μm | 52 μm | −3 | μm |
| Blue coat on CFRP | 64 μm | 75 μm | 11 | μm |
| Primer coat on CFRP | 50 μm | 52 μm | 2 | μm |
| Primer coat on CFRP | 77 μm | 64 μm | −13 | μm |

The table above shows the results for different combinations of paint coated on the CFRP substrate. For a single layer of paint, the average measurement error is approximately 5 μm. For a dual layer of paint, the average measurement error is approximately 14 μm.

Several factors may contribute to the measurement error. Firstly, the surface of the CFRP substrate is inhomogeneous and rough and may therefore cause inconsistencies in the results. Secondly, the paint coated on the CFRP substrate may not be uniform. With the surface profiler, measurements were taken at the corner of the sample, whereas measurements for the paint thickness measurement method 50 were taken at the centre of the sample. It is possible that the paint thicknesses at the corner and the centre are different.

As is evident from the foregoing discussion, the present invention provides a non-contact, non-destructive and less time-consuming paint thickness measuring device and computer-implemented method for measuring paint thickness that does away with additional repainting process requirements, thereby saving a huge amount of time and negating the risk of damaging the skin of an aircraft. Further advantageously, the paint thickness measuring device of the present invention is compact, lightweight and portable, making it easy to carry around when performing remote measurements on aircraft. By using a continuous-wave terahertz (cw-THz) system, THz penetrating into paint better than Near Infrared (NIR) and optical frequencies, the paint thickness measuring device and method of the present invention is capable of measuring thin (less than 125 μm) layers of paint in a multi-layer structure simultaneously. The minimum thickness this system is capable of measuring is 40 μm with a measurement error less than 10%, which may be further reduced depending on the surface and intrinsic material properties of the paint. Through the provision of diffractive optical elements (DOEs), the paint thickness measuring device is able to measure paint from further distances, making it suitable to be fitted into a drone when sufficient clearance between the drone and the aircraft is required. Further advantageously, the paint thickness measuring device and method of the present invention uses an algorithm that minimizes a cross-correlation error function between an experimental reflected wave and a simulated reflected wave.

While preferred embodiments of the invention have been described, it will be clear that the invention is not limited to the described embodiments only. Numerous modifications, changes, variations, substitutions and equivalents will be apparent to those skilled in the art without departing from the scope of the invention as described in the claims. For example, although described in relation to measuring the thickness of paint on an aircraft, the present invention is not limited to such applications and may, for example, also be used to measure the thickness of paint on a vehicle or pipe to check for corrosion.

Further, unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A paint thickness measuring device, comprising:
a first continuous-wave (cw) laser;
a second continuous-wave laser;
a photomixer comprising:
an optical coupler configured to mix laser lights emitted by the first and second continuous-wave lasers and generate a terahertz (THz) wave,
a photomixer emitter configured to emit the terahertz wave, and
a photomixer receiver configured to detect the terahertz wave reflected off a painted surface;
one or more computer processors; and
a non-transitory computer-readable memory storing computer program instructions executable by the one or more computer processors to perform operations for paint thickness measurement, the operations comprising:
comparing the detected terahertz wave to simulation results;
identifying a minimum difference between the detected terahertz wave and the simulation results; and
determining a paint thickness of the painted surface from the simulation results with the minimum difference.

2. The paint thickness measuring device according to claim 1, further comprising a first Fresnel lens configured to focus the emitted terahertz wave from the photomixer emitter and a second Fresnel lens configured to refocus the terahertz wave reflected off the painted surface, each of the first and second Fresnel lenses having a diffractive optical element (DOE).

3. The paint thickness measuring device according to claim 2, wherein each of the first and second Fresnel lenses has a refractive index of about 3.44.

4. The paint thickness measuring device according to claim 2, wherein each of the first and second Fresnel lenses has a focal length of between about 10 centimetres (cm) and about 100 cm.

5. The paint thickness measuring device according to claim 1, wherein the simulation results are stored in a calibration table.

6. The paint thickness measuring device according to claim 1, further comprising:
adjusting material parameters and a simulated paint thickness of a simulation model to minimise a difference between the detected terahertz wave and the simulation model.

7. The paint thickness measuring device according to claim 6, wherein the difference between the detected terahertz wave and the simulation model is represented by an error function defined by a cross-correlation of the detected terahertz wave and the simulation model as defined by Equations (1) and (2):
$${r}_{i n} ★ {r}_{trial} ( τ ) = {\int }_{- ∞}^{∞} {r}_{i n} ( f ) {r}_{trial}^{*} ( f + τ ) df \qquad ( 1 )$$
$$F \{ {r}_{i n} ★ {r}_{trial} ( τ ) \} = {R}_{i n} ( t ) * {R}_{trial} ( t ) \qquad ( 2 )$$
wherein
rᵢₙ represents the detected terahertz wave,
rₜᵣᵢₐₗ represents a simulated waveform,
τ represents a dummy variable for integration,
f represents frequency,
Rᵢₙ represents a Fourier transform pair of rᵢₙ,
Rₜᵣᵢₐₗ represents a Fourier transform pair of rₜᵣᵢₐₗ,
t represents a time delay, and
Equation (2) is a Fourier transform of Equation (1).

8. The paint thickness measuring device according to claim 7, wherein the operation of identifying the minimum difference between the detected terahertz wave and the simulation results further comprises:
mapping a magnitude of the detected terahertz wave into a time-domain using Equation (2) to obtain a magnitude component and an angle component.

9. The paint thickness measuring device according to claim 8, wherein the operation of identifying the minimum difference between the detected terahertz wave and the simulation results further comprises:
performing a filtering operation to remove the magnitude and angle components in the time-domain that are orders of magnitude lower than the magnitude and angle components at t=0.

10. The paint thickness measuring device according to claim 9, wherein the operation of identifying the minimum difference between the detected terahertz wave and the simulation results further comprises:
reconstructing the detected terahertz wave with the filtered magnitude and angle components.

11. (canceled)

12. The paint thickness measuring device according to claim 6, wherein a particle swarm optimization (PSO) method is used to minimise the difference between the detected terahertz wave and the simulation model.

13. The paint thickness measuring device according to claim 12, wherein the particle swarm optimization (PSO) method comprises populating corners of a solution space with a plurality of particles.

14. A computer-implemented method for measuring paint thickness using the paint thickness measuring device of claim 1, the method comprising executing on the one or more computer processors the steps of:
comparing the detected terahertz wave to simulation results;
identifying a minimum difference between the detected terahertz wave and the simulation results; and
determining a paint thickness of the painted surface from the simulation results with the minimum difference.

15. The computer-implemented method for measuring paint thickness according to claim 14, wherein the simulation results are stored in a calibration table.

16. The computer-implemented method for measuring paint thickness according to claim 14, further comprising:
adjusting material parameters and a simulated paint thickness of a simulation model to minimise a difference between the detected terahertz wave and the simulation model.

17. The computer-implemented method for measuring paint thickness according to claim 16, wherein the difference between the detected terahertz wave and the simulation model is represented by an error function defined by a cross-correlation of the detected terahertz wave and the simulation model as defined by Equations (1) and (2):
$${r}_{i n} ★ {r}_{trial} ( τ ) = {\int }_{- ∞}^{∞} {r}_{i n} ( f ) {r}_{trial}^{*} ( f + τ ) df \qquad ( 1 )$$
$$F \{ {r}_{i n} ★ {r}_{trial} ( τ ) \} = {R}_{i n} ( t ) * {R}_{trial} ( t ) \qquad ( 2 )$$
wherein
rᵢₙ represents the detected terahertz wave,
rₜᵣᵢₐₗ represents a simulated waveform,
τ represents a dummy variable for integration,
f represents frequency,
Rᵢₙ represents a Fourier transform pair of rᵢₙ,
Rₜᵣᵢₐₗ represents a Fourier transform pair of rₜᵣᵢₐₗ,
t represents a time delay, and
Equation (2) is a Fourier transform of Equation (1).

18. The computer-implemented method for measuring paint thickness according to claim 17, wherein the step of identifying the minimum difference between the detected terahertz wave and the simulation results further comprises:
mapping a magnitude of the detected terahertz wave into a time-domain using Equation (2) to obtain a magnitude component and an angle component.

19. The computer-implemented method for measuring paint thickness according to claim 18, wherein the step of identifying the minimum difference between the detected terahertz wave and the simulation results further comprises:
performing a filtering operation to remove the magnitude and angle components in the time-domain that are orders of magnitude lower than the magnitude and angle components at t=0.

20-21. (canceled)

22. The computer-implemented method for measuring paint thickness according to claim 16, wherein a particle swarm optimization (PSO) method is used to minimise the difference between the detected terahertz wave and the simulation model.

23. The computer-implemented method for measuring paint thickness according to claim 22, wherein the particle swarm optimization (PSO) method comprises populating corners of a solution space with a plurality of particles.
